(19) United States
(12) Patent Application Publication
(10) Pub. No.: US 2015/0367199 A1
(43) Pub. Date: Dec. 24, 2015

(54) GOLF CLUB HEAD AND MANUFACTURING METHOD FOR THE SAME

(71) Applicant: DUNLOP SPORTS CO., LTD., Kobe-shi (JP)

(72) Inventor: Yuki SHIMAHARA, Kobe-shi (JP)

(73) Assignee: DUNLOP SPORTS CO. LTD., Kobe-shi (JP)

(21) Appl. No.: 14/744,436

(22) Filed: Jun. 19, 2015

(30) Foreign Application Priority Data
Jun. 20, 2014 (JP) 2014-127021

(51) Int. Cl. A63B 53/04; B23K 26/36

(52) U.S. Cl. CPC A63B 53/047; B23K 26/367; A63B 2053/0445

(57) ABSTRACT

A golf club head including a face surface for hitting a ball is provided. The face surface has a plurality of score lines, a first groove pattern, and a second groove pattern. The score lines extend in a toe-heel direction. The first groove pattern is made up of first micro grooves extending along a plurality of first virtual lines. The second groove pattern is made up of second micro grooves extending along a plurality of second virtual lines intersecting the first virtual lines. At least one out of the first micro grooves and the second micro grooves extend as dashed lines interrupted in a vicinity of intersections between the first virtual lines and the second virtual lines, such that the first micro grooves and the second micro grooves do not overlap each other.

### CROSS REFERENCE TO RELATED APPLICATIONS

This application claims a priority to Japanese Patent Application No. 2014-127021 filed on Jun. 20 2014, which is hereby incorporated by reference in its entirety.

### FIELD OF INVENTION

The present invention relates to a golf club head that includes a face surface for hitting a ball, and to a manufacturing method for the same.

### BACKGROUND

Conventionally, there is known to be a golf club head in which a pattern of micro grooves is formed in addition to score lines extending in the toe-heel direction on the face surface (see Patent Literature 1 (JP 2011-234749A), Patent Literature 2 (JP 2007-202633A) and Patent Literature 3 (JP 2010-35704A)). The score lines are formed with the objective of increasing the amount of backspin applied to the ball by applying friction to the ball sliding on the face surface during hitting. Note that ordinarily, in order to maximize this friction effect, the score lines are formed so as to extend in a direction orthogonal to the trajectory of the ball on the face surface when the ball is struck “squarely” at the sweet spot (hereinafter, called the reference trajectory). However, if the ball deviates from the reference trajectory due to water accumulated in the score line in rainy weather or the like, or due to an intentional shot or mishit, there are cases where the score lines alone cannot necessarily apply a sufficient amount of backspin to the ball. In view of this, in order to ensure a sufficient amount of backspin even in such cases, there are cases where a pattern of micro grooves is formed in addition to the score lines, as described in Patent Literature 1 to 3.

Patent Literature 1 and 2 disclose straight-line micro grooves that extend parallel with the score lines. With micro grooves that are parallel with the score lines in this way, an increase in the amount of backspin is expected mainly in the case of square impact. Also, in Patent Literature 1, in addition to the micro grooves that extend parallel with the score lines, other micro grooves that extend in a straight line in a direction intersecting the above micro grooves are formed in order to improve drainage of water penetrating the above micro grooves. Also, Patent Literature 3 discloses arc-shaped micro grooves that extend so as to intersect the score lines. With these arc-shaped micro grooves, an increase in the amount of backspin is expected mainly when the ball deviates from the reference trajectory during an intentional shot or a mishit.

As described above, micro groove patterns can be formed in various ways depending on the objective. The inventors of this invention considered forming multiple patterns of micro grooves on the face surface in order to achieve various objectives. In this case, the micro grooves may intersect with each other. The inventors of this invention then noticed the problem that in this case, the micro grooves interfere with each other during groove formation and flatten each other's groove shoulders, thus making it impossible to achieve the objective of increasing the amount of backspin.

SUMMARY of INVENTION

An object of the present invention is to provide a golf club head that can apply a sufficient amount of backspin to the ball, and a manufacturing method for the same.

A golf club head according to a first aspect of the present invention includes a face surface for hitting a ball. The face surface has a plurality of score lines, a first groove pattern, and a second groove pattern. The score lines extend in a toe-heel direction. The first groove pattern is made up of first micro grooves extending along a plurality of first virtual lines. The second groove pattern is made up of second micro grooves extending along a plurality of second virtual lines intersecting the first virtual lines. At least one out of the first micro grooves and the second micro grooves extend as dashed lines interrupted in a vicinity of intersections between the first virtual lines and the second virtual lines, such that the first micro grooves and the second micro grooves do not overlap each other.

A golf club head according to a second aspect of the present invention is the golf club head according to the first aspect, wherein the second virtual lines are shaped as arcs.

A golf club head according to a third aspect of the present invention is the golf club head according to the second aspect, wherein the second virtual lines are shaped as arcs centered about a position located outward of a lower end edge of the face surface.

A golf club head according to a fourth aspect of the present invention is the golf club head according to the second aspect or the third aspect, wherein the second virtual lines are shaped as arcs centered about a point on a third virtual line passing through a sweet spot region and substantially orthogonal to the score lines.

A golf club head according to a fifth aspect of the present invention is the golf club head according to any one of the first to fourth aspects, wherein the first micro grooves extend as straight lines in the toe-heel direction between adjacent score lines.

A golf club head according to a sixth aspect of the present invention is the golf club head according to any one of the first to fifth aspects, wherein the first micro grooves extend in a continuous manner, and the second micro grooves extend as dashed lines.

A golf club head according to a seventh aspect of the present invention is the golf club head according to the sixth aspect, wherein a width of the first micro grooves is wider than a width of the second micro grooves.

A golf club head according to an eighth aspect of the present invention is the golf club head according to any one of the first to seventh aspects, wherein the second virtual lines extend so as to intersect the score lines. Also, the second micro grooves extend as dashed lines interrupted in a vicinity of intersections between the score lines and the second virtual lines so as to not be overlapped with the score lines.

A manufacturing method for a golf club head according to a ninth aspect of the present invention is a manufacturing method for a golf club head that includes a face surface for hitting a ball, the method including the following steps (1) to (3). Note that the following steps are in no particular order.

(1) A step of forming a plurality of score lines on the face surface along a toe-heel direction.

(2) A step of forming a first groove pattern on the face surface using a laser, the first groove pattern being made up of first micro grooves extending along a plurality of first virtual lines.

(3) A step of forming a second groove pattern on the face surface using a laser, the second groove pattern being made up of second micro grooves extending along a plurality of second virtual lines intersecting the first virtual lines.

Also, at least one out of step (2) and step (3) includes a step of forming at least one out of the first micro grooves and the second micro grooves so as to extend as dashed lines interrupted in a vicinity of intersections between the first virtual lines and the second virtual lines, such that the first micro grooves and the second micro grooves do not overlap each other.

According to the first aspect of the present invention, a first micro groove pattern and a second micro groove pattern are formed in addition to score lines on the face surface of the golf club head. Virtual lines (the first virtual lines) drawn by the first micro grooves overall and virtual lines (the second virtual lines) drawn by the second micro grooves overall intersect each other, but the grooves themselves do not overlap each other and do not interfere with each other. As a result, the first micro grooves and the second micro grooves do not flatten each other's shoulders during groove formation, it is possible to increase the amount of backspin, and it is possible to prevent a decrease in spin performance. Accordingly, it is possible to form different patterns of micro grooves and achieve their respective objectives, and it is possible to apply a sufficient amount of backspin to the ball.

Also, according to the second to fourth aspects, it is possible to apply a sufficient amount of backspin to the ball not only when the ball is squarely seized at the sweet spot, but also during an intentional shot, a mishit, or the like. In other words, even if the ball slides on the face surface in a direction inclined relative to the reference trajectory, it is possible to apply a sufficient amount of backspin to the ball.

According to the fourth aspect in particular, it is possible to apply a sufficient amount of backspin to the ball even in the case where the trajectory of the ball is inclined to either the toe side or the heel side relative to the reference trajectory. Note that generally, during a shot in the open face state, when applying so-called fade spin, or the like, the trajectory of the ball is inclined toward the toe side relative to the reference trajectory on the face surface, and during a shot in the closed face state, when applying so-called draw spin, or the like, the trajectory is inclined toward the heel side.

Also, according to the fifth aspect, it is possible to effectively increase the amount of backspin during a square impact.

Furthermore, according to the sixth aspect, it is possible to improve the hydrophobic effect with the first micro grooves, while also increasing the amount of backspin with the second micro grooves. In particular, if the first micro grooves are grooves that extend as straight lines in the toe-heel direction, and the second micro grooves are arc-shaped grooves, it is possible to improve the hydrophobic effect with the straight-line grooves, while also increasing the amount of backspin during an intentional shot, a mishit, or the like with the arc-shaped grooves.

Also, according to the seventh aspect, it is possible to further improve the hydrophobic effect with the first micro grooves that extend over a wide range in a continuous manner, and the effect of increasing the amount of backspin with the second micro grooves is improved.

Also, if the score lines and micro grooves intersect and overlap each other, there are cases where the grooves become deeper than the actual design values in the intersecting portions during groove formation. The depth of the grooves that may be formed in the face surface is prescribed in official golf rules, and this rule can be violated in this case. However, according to the eighth aspect, the score lines and the second micro grooves are configured so as to not overlap each other and not interfere with each other. As a result, it is possible to easily manufacture a golf club head that is compliant with golf rules.

Also, according to the ninth aspect, groove formation is performed using a laser, thus making it possible to easily form the first micro groove pattern and the second micro groove pattern so as to not interfere with each other.

### BRIEF DESCRIPTION OF DRAWINGS

FIG. 1 is a diagram showing a golf club head according to an embodiment of the present invention, as viewed from the face surface side;

FIG. 2 is a partial enlarged view of the region inside a circle C1 in FIG. 1;

FIGS. 3A to 3E are diagrams for describing trajectories of a ball on the face surface in various shots; and

FIGS. 4A to 4C are diagrams showing cross-sectional shapes of grooves in the depth direction.

### DETAILED DESCRIPTION OF THE PREFERRED EMBODIMENTS

The following describes a golf club head and a manufacturing method for the same according to an embodiment of the present invention with reference to the drawings.

1. Configuration of Golf Club Head

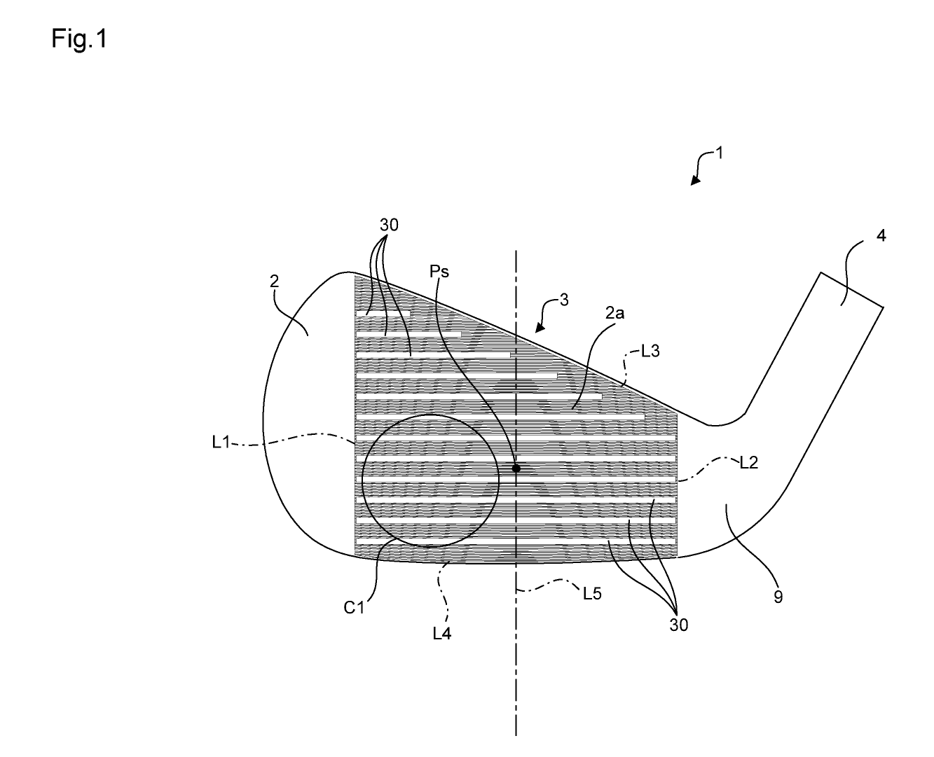

FIG. 1 is a diagram showing a golf club head 1 according to the present embodiment, as viewed from a face surface 2 side. The golf club head 1 of the present embodiment is an iron-type golf club head. Later-described characteristic textured patterns of grooves are formed on the face surface 2 mainly with the objective of increasing the amount of ball backspin, and similar groove patterns are also applicable to wood-type, utility-type, and other types of golf club heads.

The golf club head 1 is constituted by a metal material, and as shown in FIG. 1, includes a head body portion 3 and a hosel portion 4 integrally provided on the head body portion 3 via a neck portion 9. The hosel portion 4 is a cylindrical member into which the shaft of the golf club is inserted. The face surface 2, which defines a flat surface with the exception of various later-described grooves, is formed on the head body portion 3.

The face surface 2 is a ball hitting surface, and has a groove formation region 2a in the center, in which various grooves are formed. The groove formation region 2a is defined by a toe line L1, a heel line L2, a top line L3, and a sole line L4. In the present embodiment, the top line L3 extends along the top of the head body portion 3, and the sole line L4 extends along the sole of the head body portion 3. In other words, the top line L3 is a line that extends along the upper end edge of the face surface 2, and the sole line L4 is a line that extends along the lower end edge of the face surface 2. Also, the toe line L1 and the heel line L2 are straight lines that extend substantially parallel with each other from the top line L3 to the sole line L4, and are substantially orthogonal to a line obtained by projecting the sole line L4 on the ground along the face surface 2 at the time of address or impact. Note that these lines L1 to L4 may be visible lines, or may be invisible lines.

As shown in FIG. 1, multiple score lines 30 that are parallel with each other are formed on the face surface 2. In the present embodiment, the score lines 30 are straight-line grooves that extend in a continuous manner along the toe-heel direction, and are substantially parallel with a line obtained by projecting the sole line L4 on the ground along the face surface 2 at the time of address or impact. The score lines 30 extend roughly from the toe line L1 to the heel line L2 on the sole side, and extend roughly from the toe line L1 to the top line L3 on the top side. Also, the score lines 30 are arranged at substantially equal intervals between the top line L3 and the sole line L4.

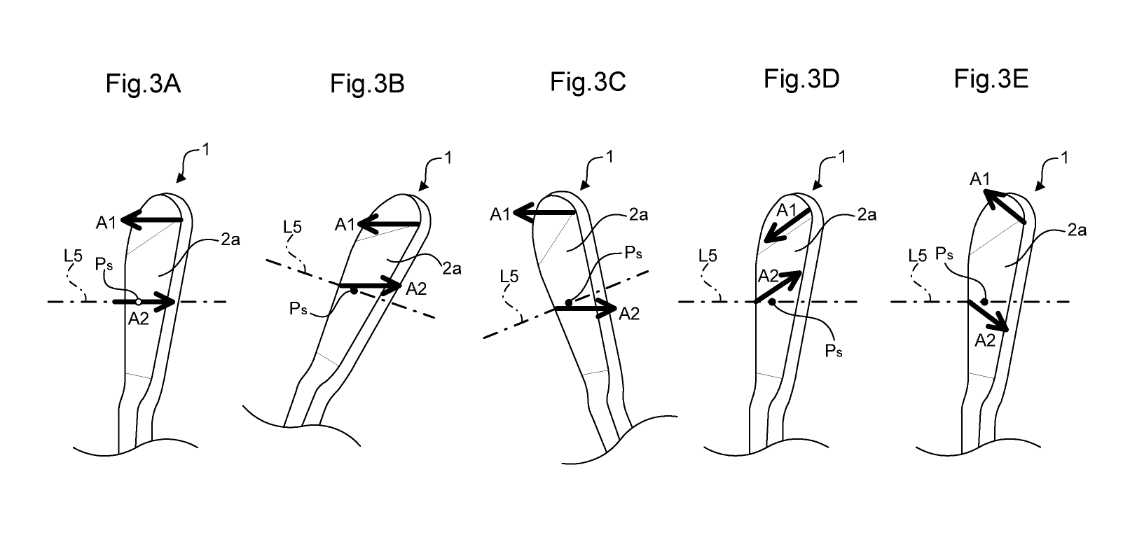

The score lines 30 can increase the amount of backspin applied to the ball by applying friction to the ball sliding on the face surface 2 during hitting. In particular, in the present embodiment, the score lines 30 are formed along a direction substantially orthogonal to the reference trajectory, and thus can effectively increase the amount of ball backspin during square impact. Note that the reference trajectory is the trajectory of the ball on the face surface 2 during a shot in which the ball is struck “squarely” at a sweet spot Ps (see FIG. 3A). Specifically, the reference trajectory is a trajectory that extends along a center line L5 that passes through the sweet spot Ps region and is substantially orthogonal to the score lines 30. Also, the sweet spot Ps is the intersection of the face surface 2 and a line that passes through the center of gravity of the golf club head 1 and is perpendicular to the face surface 2.

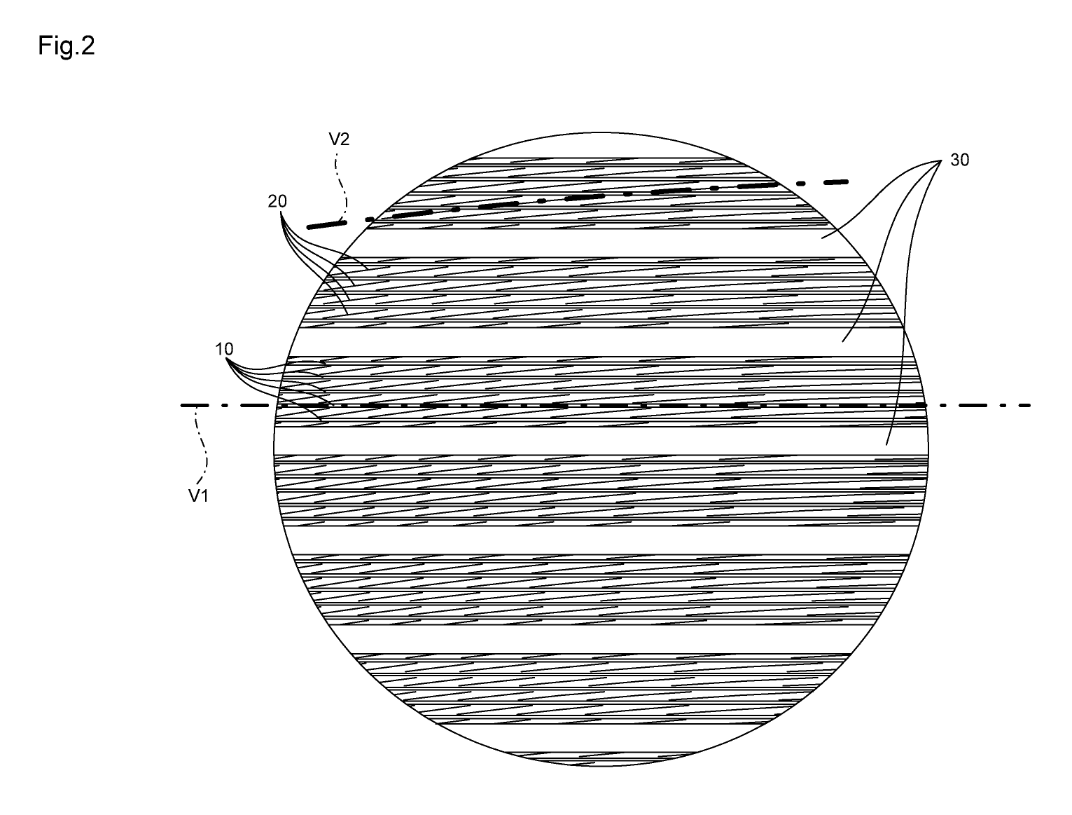

FIG. 2 is a partial enlarged view of the region inside a circle Cl in FIG. 1. As shown in FIG. 2, besides the score line 30 groove pattern, two patterns of grooves smaller than the score lines 30 are formed on the face surface 2. One of the groove patterns is a groove pattern made up of multiple straight-line first micro grooves 10 that are parallel with the score lines 30, and the other one is a groove pattern made up of multiple arc-shaped second micro grooves 20.

The first micro grooves 10 extend in a continuous manner roughly from the toe line L1 to the heel line L2 along first virtual lines V1 that are parallel with the score lines 30. There are multiple first micro grooves 10 between adjacent score lines 30, and these first micro grooves 10 are arranged at substantially equal intervals between the top line L3 and the sole line L4 with the exception of the regions in which the score lines 30 are formed.

Similarly to the score lines 30, the first micro grooves 10 can also increase the amount of ball backspin by applying friction to the ball sliding on the face surface 2 during hitting. In particular, in the present embodiment, the first micro grooves 10 extend parallel with the score lines 30, and thus can effectively increase the amount of ball backspin during square impact, similarly to the score lines 30.

Also, the first micro grooves 10 and the score lines 30 both extend in a continuous manner from the toe line L1 to the heel line L2, and thus effectively exhibit a hydrophobic effect. Accordingly, with the golf club head 1, it is possible to prevent a reduction in the amount of backspin during rainy weather or the like.

On the other hand, the second micro grooves 20 extend along an arc-shaped second virtual line V2 that intersects the first virtual lines V1, and extend as a dashed line interrupted in the vicinity of intersections between the second virtual line V2 and the first virtual lines V1. Note that the second virtual line V2 is an arc-shaped line centered about a point Pc (not shown) that is on the center line L5 and is located outward of the sole line L4 with respect to the face surface 2. Also, there are multiple second virtual lines V2 at substantially equal intervals in the radial direction from the point Pc. The second virtual lines V2 have an upward protruding shape, have a crest on the center line L5, and are shaped so as to be inclined downward on the toe side and the heel side relative to the center line L5. Note that regarding the terms “up” and “down” used here, up refers to the top side, and down refers to the sole side. Moreover, the second virtual lines V2 intersect the score lines 30 as well, and although it is not clear in FIG. 2, the second micro grooves 20 are interrupted in the vicinity of intersections between the score lines 30 and the second virtual lines V2 as well. As a result, the second micro grooves 20 are overlapped with neither the first micro grooves 10 nor the score lines 30.

The second micro grooves 20 can effectively apply backspin to a ball moving over the face surface 2 at an angle relative to the reference trajectory during an intentional shot, a mishit, or the like. Specifically, during a shot in the open face state shown in FIG. 3B, when applying so-called fade spin as shown in FIG. 3D, or the like, the trajectory of the ball is inclined toward the toe side relative to the reference trajectory on the face surface 2. On the other hand, during a shot in the closed face state shown in FIG. 3C, when applying draw spin as shown in FIG. 3E, or the like, the trajectory of the ball is inclined toward the heel side relative to the reference trajectory on the face surface 2. The second micro grooves 20 are relatively orthogonal to a ball traveling with a trajectory deviating from the reference trajectory on the face surface 2. As a result, the ball is likely to be caught by the second micro grooves 20 during an intentional shot, a mishit, or the like, and the second micro grooves 20 can effectively increase the amount of ball backspin. Note that in FIGS. 3A to 3E, an arrow A1 indicates the movement direction of the golf club head 1 during impact, and an arrow A2 indicates the direction of movement of the ball.

Also, as described above, the second micro grooves 20 are not overlapped with and do not interfere with the first micro grooves 10. As a result, the first micro grooves 10 and the second micro grooves 20 do not flatten each other's shoulders during groove formation, and there is no decrease in the spin performance of the first micro grooves 10 and the second micro grooves 20. Also, the second micro grooves 20 do not interfere with the score lines 30 either, and thus similar effects are obtained with respect to the relationship between the second micro grooves 20 and the score lines 30 as well.

The following describes the dimensions and cross-sectional shapes, with respect to the groove depth direction, of the score lines 30, the first micro grooves 10, and the second micro grooves 20. Note that the cross-sectional shapes and dimensions of the grooves 10 to 30 described below are merely examples, and can be changed as appropriate while following official golf rules. There is no need to follow official golf rules if the golf club is not a golf club for competition or the like.

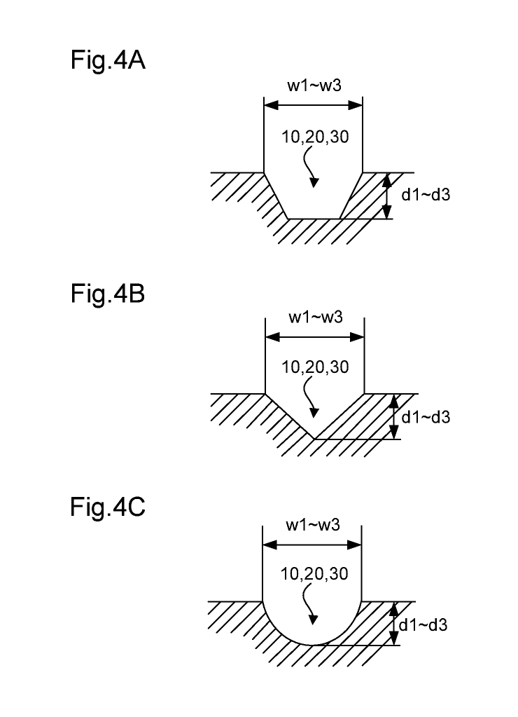

The depth-direction cross-sectional shapes of the score lines 30, the first micro grooves 10, and the second micro grooves 20 may be similar to each other (similar shapes), or may be different shapes. For example, the cross-sectional shapes of the grooves 10 to 30 may be trapezoidal with a width that decreases toward the base as shown in FIG. 4A, may be V-shaped as shown in FIG. 4B, or may be arc-shaped as shown in FIG. 4C.

A depth d1 of the first micro grooves 10 is less than 0.03 mm, and d1≦0.025 mm is set when following golf rules. Similarly, a depth d2 of the second micro grooves 20 is less than 0.03 mm, and d2≦0.025 mm is set when following golf rules. Also, although d1=d2 in the present embodiment, d1 and d2 can also be set to different values.

Also, a width w1 of the first micro grooves 10 is 0.10 mm to 0.30 mm. Similarly, a width w2 of the second micro grooves 20 is 0.10 mm to 0.30 mm. Note that w1>w2 in the present embodiment.

A depth d3 of the score lines 30 is greater than or equal to 0.200 mm, and d3>d1,d2. Note that d3≦0.508 mm when following golf rules. Also, a width w3 of the score lines is 0.50 mm to 0.85 mm, and is less than or equal to 0.90 mm when following golf rules. Note that the edges (shoulders) of the score lines 30 can be chamfered. In the case of chamfering, the groove width w3 of the score lines 30 is set based on the R&A rule of “30 degree method of measurement”.

Also, s3>s1>s2, where s1, s2, and s3 are respectively the gaps between the first virtual lines V1, the second virtual lines V2, and the score lines 30 in the direction from the top line L3 toward the sole line L4. Accordingly, in the present embodiment, there are more second micro grooves 20 than first micro grooves 10. When the ball starts to roll on the face surface 2, it starts to roll with acceleration. Since there is a large number of second micro grooves 20 in the present embodiment, the start of backspin is effectively promoted if the ball deviates from the reference trajectory, and a sufficient amount of backspin can be ensured. Note that the number of second micro grooves 20 referred to here is a value obtained by counting all of the second micro grooves 20 on the same second virtual line V2 as one groove. Also, s1, s2, and s3 do not need to be constant values. In other words, the first virtual lines V1, the second virtual lines V2, and the score lines 30 do not need to be equally spaced.

2. Golf Club Head Manufacturing Method

The following describes a manufacturing method for the golf club head 1 of the present embodiment, with focus on the method for forming the score lines 30, the first micro grooves 10, and the second micro grooves 20.

First, a golf club head 1 not having the grooves 10 to 30 formed on the face surface 2 is prepared. The score lines 30 are then formed on the face surface 2 in this state. This step is realized by any method, such as NC machining or press machining in which a die having protrusions shaped opposite to the score lines 30 is pressed against the face surface 2.

In the present embodiment, after forming the score lines 30, the first micro grooves 10 and the second micro grooves 20 are formed in the face surface 2. The first micro grooves 10 and the second micro grooves 20 are formed by laser milling. The regions in which score line 30 and first micro groove 10 are or are to be formed on the face surface 2 are not irradiated by the laser when forming the second micro grooves 20. The formation of the first micro grooves 10 and the formation of the second micro grooves 20 may be performed separately as independent steps, but either may be executed first. Due to using laser milling in the present embodiment, it is possible to relatively easily realize fine control for avoiding interference of the second micro grooves 20 with the first micro grooves 10 and the score lines 30. Note that as long as it is possible to prevent interference between the first micro grooves 10 and the second micro grooves 20, it is possible to form the first micro grooves 10 and the second micro grooves 20 using a method other than laser milling, such as NC machining. Also, the first micro grooves 10 and the second micro grooves 20 can also be formed before formation of the score lines 30.

3. Features

In the above embodiment, patterns of first micro grooves 10 and second micro grooves 20 are formed in addition to the score lines 30 on the face surface 2 of the golf club head 1. Also, the first micro grooves 10 and the second micro grooves 20 do not overlap each other, and do not interfere with each other. As a result, the first micro grooves 10 and the second micro grooves 20 do not flatten each other's shoulders during groove formation, it is possible to increase the amount of backspin, and it is possible to prevent a decrease in spin performance. Accordingly, a sufficient amount of backspin can be applied to the ball. Also, there are cases where the face surface 2 is subjected to plating. In this case as well, since the first micro grooves 10 and the second micro grooves 20 do not interfere with each other, it is easy to perform control for setting the groove depth lower than the plating thickness. Accordingly, it is possible to suppress the growth of rust on the face surface 2, for example.

Also, if the score lines 30 and the second micro grooves 20 intersect and overlap each other, there are cases where the grooves become deeper than the actual design values in the intersecting portions during groove formation. The depth of the grooves that may be formed in the face surface is prescribed in official golf rules, and this rule can be violated in this case. However, in the configuration described here, the score lines 30 and the second micro grooves 20 do not overlap each other, and do not interfere with each other. As a result, it is possible to easily form grooves on the face surface 2 that comply with golf rules.

Also, in the above embodiment, due to the existence of the second micro grooves 20, it is possible to apply a sufficient amount of backspin to the ball not only when the ball is squarely seized at the sweet spot Ps, but also during an intentional shot, a mishit, or the like. In other words, even if the ball slides on the face surface 2 in a direction inclined relative to the reference trajectory, it is possible to apply a sufficient amount of backspin to the ball. Also, the amount of backspin can be increased by the existence of the first micro grooves 10 as well. Moreover, the first micro grooves 10 extend widely in a continuous manner in the toe-heel direction, thus making it possible to improve the hydrophobic effect.

4. Variations

Although an embodiment of the present invention has been described above, the present invention is not limited to this embodiment, and various modifications can be made without departing from the gist of the invention. The following are examples of modifications that can be made. Any combination of the features of the following variations can be used as appropriate.

4-1

In the above embodiment, in the vicinity of the intersections between the first virtual lines V1 and the second virtual lines V2, out of the first micro grooves 10 and the second micro grooves 20, only the second micro grooves 20 are interrupted, but a configuration is possible in which both the micro grooves 10 and 20 are interrupted, and a configuration is possible in which only the first micro grooves 10 are interrupted.

4-2

The second virtual line V2 drawn by the second micro grooves 20 is not limited to the above-described aspect, and it is possible for the second micro grooves 20 to draw a downward protruding arc shape, or for the arc center Pc to be offset to the toe side or the heel side rather than being on the center line L5, for example. Also, both of these variations can be employed. Moreover, the second virtual line V2 is not limited to being arc-shaped, and can be a curved line that simply protrudes upward or downward. Furthermore, the second virtual lines V2 can be straight lines that intersect the first virtual lines V1 and the score lines 30 in an oblique direction.

4-3

The first virtual lines V1 drawn by the first micro grooves 10 do not need to be straight lines, and may be curved lines or broken lines, for example. Note that it is preferable that the first virtual line V1 overall extends in the toe-heel direction between adjacent score lines 30.

### REFERENCE SIGNS LIST

1 Golf club head

2 Face surface

10 First micro groove

20 Second micro groove

30 Score line

Ps Sweet spot

V1 First virtual line

V2 Second virtual line

1. A golf club head comprising a face surface for hitting a ball,
the face surface having
a plurality of score lines extending in a toe-heel direction,
a first groove pattern made up of first micro grooves extending along a plurality of first virtual lines, and
a second groove pattern made up of second micro grooves extending along a plurality of second virtual lines intersecting the first virtual lines, and
at least one out of the first micro grooves and the second micro grooves extend as dashed lines interrupted in a vicinity of intersections between the first virtual lines and the second virtual lines, such that the first micro grooves and the second micro grooves do not overlap each other.

2. The golf club head according to claim 1, wherein the second virtual lines are shaped as arcs.

3. The golf club head according to claim 2, wherein the second virtual lines are shaped as arcs centered about a position located outward of a lower end edge of the face surface.

4. The golf club head according to claim 2, wherein the second virtual lines are shaped as arcs centered about a point on a third virtual line passing through a sweet spot region and substantially orthogonal to the score lines.

5. The golf club head according to claim 1, wherein the first micro grooves extend as straight lines in the toe-heel direction between adjacent score lines.

6. The golf club head according to claim 1, wherein the first micro grooves extend in a continuous manner, and the second micro grooves extend as dashed lines.

7. The golf club head according to claim 6, wherein a width of the first micro grooves is wider than a width of the second micro grooves.

8. The golf club head according to claim 1,
wherein the second virtual lines extend so as to intersect the score lines, and
the second micro grooves extend as dashed lines interrupted in a vicinity of intersections between the score lines and the second virtual lines so as to not be overlapped with the score lines.

9. The golf club head according to claim 3, wherein the second virtual lines are shaped as arcs centered about a point on a third virtual line passing through a sweet spot region and substantially orthogonal to the score lines.

10. The golf club head according to claim 2, wherein the first micro grooves extend as straight lines in the toe-heel direction between adjacent score lines.

11. The golf club head according to claim 3, wherein the first micro grooves extend as straight lines in the toe-heel direction between adjacent score lines.

12. The golf club head according to claim 4, wherein the first micro grooves extend as straight lines in the toe-heel direction between adjacent score lines.

13. The golf club head according to claim 9, wherein the first micro grooves extend as straight lines in the toe-heel direction between adjacent score lines.

14. The golf club head according to claim 2, wherein the first micro grooves extend in a continuous manner, and the second micro grooves extend as dashed lines.

15. The golf club head according to claim 3, wherein the first micro grooves extend in a continuous manner, and the second micro grooves extend as dashed lines.

16. The golf club head according to claim 4, wherein the first micro grooves extend in a continuous manner, and the second micro grooves extend as dashed lines.

17. The golf club head according to claim 5, wherein the first micro grooves extend in a continuous manner, and the second micro grooves extend as dashed lines.

18. The golf club head according to claim 10, wherein a width of the first micro grooves is wider than a width of the second micro grooves.

19. The golf club head according to claim 10,
wherein the second virtual lines extend so as to intersect the score lines, and
the second micro grooves extend as dashed lines interrupted in a vicinity of intersections between the score lines and the second virtual lines so as to not be overlapped with the score lines.

20. A manufacturing method for a golf club head including a face surface for hitting a ball, the method comprising:
a step of forming a plurality of score lines on the face surface along a toe-heel direction;
a step of forming a first groove pattern on the face surface using a laser, the first groove pattern being made up of first micro grooves extending along a plurality of first virtual lines; and
a step of forming a second groove pattern on the face surface using a laser, the second groove pattern being made up of second micro grooves extending along a plurality of second virtual lines intersecting the first virtual lines,
at least one out of the step of forming the first micro grooves and the step of forming the second micro grooves includes a step of forming at least one out of the first micro grooves and the second micro grooves so as to extend as dashed lines interrupted in a vicinity of intersections between the first virtual lines and the second virtual lines, such that the first micro grooves and the second micro grooves do not overlap each other.
